(19) United States
(12) Patent Application Publication
(10) Pub. No.: US 2007/0297957 A1
(43) Pub. Date: Dec. 27, 2007

(54) Spinning Disc Reactor with Enhanced Sprader Plate Features

(76) Inventors: John Robert Burns, Sunderland (GB); Ian Henderson, Middlesbrough (GB)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/573,775

(22) PCT Filed: Aug. 15, 2005
(86) PCT No.: PCT/GB05/03195

§ 371 Date: Feb. 15, 2007

(30) Foreign Application Priority Data
Aug. 18, 2004 (GB) 04184123

(51) Int. Cl. B01J 19/18

(52) U.S. Cl. 422/198

(57) ABSTRACT

There is disclosed a spinning disc reactor having a reaction surface and a hollow main body within which is disposed a spreader plate for defining a flow path for heat transfer fluid. The spreader plate is profiled so that the distance between an internal surface of the main body of the spinning disc reactor and the spreader plate is not constant along a radius of the spinning disc reactor, thereby allowing the radial velocity of the heat transfer fluid to be controlled, for example so as to be constant. This arrangement gives rise to improved heat transfer performance.

The present invention relates to a rotating surface of revolution reactor or spinning disc reactor for mass and heat transfer applications, and in particular to such a reactor provided with a first, external surface for radial passage of a reactant thereacross, and a second, internal surface forming part of a flow path for a heat transfer fluid for controlling a temperature at the first surface.

Rotating reactors or spinning disc reactors (SDRs) for mass and heat transfer applications are known from the present applicant's International patent applications WO00/48731, WO00/48729, WO00/48732, WO00/48730 and WO00/48728, the full contents of which are hereby incorporated into the present application by reference. Rotating reactors generally comprise a rotating or spinning surface, for example a disc or a cone, onto which one or more liquid reactants are supplied. Centrifugal forces cause the reactants to pass outwardly across the surface (i.e. centrifugal acceleration is aligned with a surface radius vector) in the form of a thin generally wavy film, the film then being thrown from a circumference of the surface for collection. The thin film generated on the disc combined with the shearing action and surface wave convection creates conditions that promote excellent mixing within the film and rapid beat and mass transfer through the film. It is to be appreciated that the generation of a thin, generally wavy and radially outwardly-moving film of reactant on the spinning surface is a key feature of SDR technology, including the present invention.

The closest prior art to the present invention is considered to be WO00/48732. This discloses a reactor apparatus including a hollow support element adapted to be rotatable about an axis, the support element having a first, external reaction surface and a second, internal heat transfer surface and means for applying a heat transfer fluid to the second surface, the first and second surfaces being in thermal communication with each other and the support element including an internal space bounded on one side by the second surface, characterised in that a plate or membrane is provided inside the hollow support element, the plate or membrane extending substantially over the whole internal space so as to define a first space between the second surface and one side of the plate or membrane and a second space between an opposed side of the plate or membrane and an internal surface of the support element remote from the second surface, but leaving a gap at a periphery of the plate or membrane so as to allow a heat transfer fluid to flow between the first and second spaces.

A somewhat similar arrangement is described in U.S. Pat. No. 2,210,928.

However, in the reactors of the prior at the internal plate or membrane, otherwise known as a “spreader plate”, is configured to be parallel to the second, internal heat transfer surface of the support element. While this arrangement may be convenient in terms of manufacture, it has certain disadvantages that will be discussed in more detail hereinbelow.

According to the present invention, there is provided a reactor apparatus including a hollow support element adapted to be rotatable about an axis, the support element having a first, external reaction surface and a second, internal heat transfer surface and means for applying a heat transfer fluid to the second surface, the first and second surface being in thermal communication with each other and the support element including an internal space bounded on one side by the second surface, wherein a plate or membrane is provided inside the hollow support element, the plate or membrane extending substantially over the whole internal space so as to define a first space between the second surface and one side of the plate or membrane and a second space between an opposed side of the plate or membrane and an internal surface of the support element remote from the second surface, but leaving a gap at a periphery of the plate or membrane so as to allow a heat transfer fluid to flow between the first and second spaces, characterised in that at least one of the plate or membrane and the second surface is shaped or profiled so that a distance between the one side of the plate or membrane and the second surface varies along a radius taken from the axis.

At least one of the other side of the plate or membrane and the internal surface of the support element remote from the second surface may also profiled or shaped so that the distance between the other side of the plate or membrane and the internal surface remote from the second surface varies along a radius taken from the axis.

The distance, or gap, between the one side of the plate or membrane and the second surface is a determining factor in the local heat transfer performance. Profiling of this gap can be made to concentrate heat transfer performance to predetermined concentric zones on the first surface. For example, profiling one or other or both of the one side of the plate or membrane and the second surface, for example by making the gap inversely proportional to the radial distance, is one possibility for achieving this result.

The distance, or gap, between the other side of the plate or membrane and the internal surface of the support element remote from the second surface may also be profiled, but this is not a determining factor in heat transfer performance. Nevertheless, this gap (the second space) should preferably be large enough to give an average, inward radial velocity substantially lower than the outward radial velocity of the heat transfer fluid in the first space. This will help to reduce unnecessary pressure drop and lowering of heat transfer performance.

In currently preferred embodiments, the distance or gap in both the first and second spaces is greatest near the axis so that the radial velocity of the heat transfer fluid does not become excessive near the axis.

In general, both the support element and the plate or membrane are generally circular and rotationaly symmetric about the axis such that the variation of the distance along the radius will be the same in all directions from the axis. However, in some embodiments the plate or membrane or the second surface may have a shape or profile that is not rotationaly symmetric about the axis.

During operation of the reactor, the support element is rotated at high speed about the axis, and a reactant is supplied to the first surface and caused to travel radially thereacross as a thin wavy film before being thrown from a periphery of the first surface. In order to control the temperature at the first surface and thus the temperature of the reactant, a heat transfer fluid is supplied to the inside of the support element so as to flow radially outwardly through the first space between the second surface and the one side of the plate or membrane, through the peripheral gap, and then radially inwardly through the second space before being abstracted and possibly recycled after cooling or healing. The radial heat transfer fluid velocity is a function of the cylindrical area for flow with the first and second spaces. Hence, at a given radius it is high for small gaps and low for large gaps.

In prior art SDR reactors with a constant spacing between the spreader plate and the second surface, the heat transfer fluid radial velocity and the consequent pressure drop will be higher close to the axis at small radial distances therefrom and lower towards the peripheral gap. This can be disadvantageous, leading to poorer heat transfer performance at outer regions of the support element, since the radial heat transfer fluid velocity will be lower.

Accordingly, by providing a varying gap between the spreader plate and the second surface and/or the internal surface remote from the second surface, embodiments of the present invention allow a velocity profile for the heat transfer fluid to be advantageously controlled, for example to be kept substantially constant along a radial direction or to vary in a predetermined manner.

The plate or membrane may have a stepped profile on one or both of its surfaces, for example comprising a series of annular shelves. Alternatively, the plate or membrane may have a smooth profile on one or both of its surfaces, which may be straight (e.g. to give a conical profile) or cured (e.g. to give a parabolic or hyperbolic profile), but not parallel to the second surface or to the surface remote from the second surface.

Alternatively or in addition, one or both of the internal surfaces of the support element may be profiled in the manner so as to achieve the desired gap profile for both the first and second spaces.

The heat transfer fluid may be gaseous or liquid, or possibly a solid in particulate form having macroscopic fluid flow properties. In typical applications, water or steam is used as the heat transfer fluid, but other fluids having different freezing and boiling points and different specific, heat capacities may be used depending on requirements.

The means for applying the heat transfer fluid to the second surface may take a number of forms. In a preferred embodiment, the support element is generally hollow, with the first surface being an external surface and the second surface being an internal surface in thermal communication with the first surface. For example, where the support element is generally planar and horizontally mounted on a drive shaft for rotation, the first surface may be an upper external surface of the body of the support element and the second surface will be the corresponding inner surface of that part of the support element. A heat transfer fluid may then be supplied to the interior of the support element possibly by way of a hollow stem drive shaft so as to contact the second surface and to transfer heat thereto or therefrom. Because the second surface is in thermal communication with the first surface, this serves to effect heat transfer to and from the first surface. Advantageously, a flow path is defined within the support element so as to provide a pathway for heat transfer fluid to circulate into and out of the support element before and after contacting the second surface. This can be achieved by providing a plate or membrane within the hollow support element which extends over substantially the whole space wit the support element but leaving a gap at peripheral regions thereof, and serving to define a first space between the second surface and one side of the plate or membrane and a second space between the other side of the plate or membrane and a portion of the support element remote from the second surface. Heat transfer fluid may then be circulated, for example tough a hollow stem drive shaft, to a central region of the first space. The heat transfer fluid is then caused to flow through the first space across the second surface, transferring heat thereto or therefrom, before flowing back to the hollow stem drive shaft via the peripheral gap and through the second space on the side of the plate or membrane remote from the second surface. Preferably, the hollow stem drive shaft comprises a pair of coaxial pipes or a pair of side-by-side (shotgun style) pipes so that heat transfer fluid can be supplied through one pipe and removed through the other, thereby reducing heat transfer between incoming and outgoing heat transfer fluid.

Advantageously, the second surface includes means for extending its effective surface area for heat transfer purposes. For example, thermally conductive vanes, fins or other projections may be provided on the second surface. Alternatively, a thermally conductive mesh or gauze or foam may be provided in the first space and in thermal contact with the second surface. The side of the plate or membrane which faces the second space may advantageously be provided with vanes, is or other projections or with a mesh or gauze or foam so as to help prevent the formation of free vortices in the heat transfer fluid which could otherwise generate a high pressure drop between input and output of the fluid. Where vanes or fins are provided, these are preferably radially oriented with respect to the axis of rotation, but in some embodiments a spiral vane or fin arrangement may be provided.

In some embodiments of the present invention, the plate or membrane is fixed relative to the support member so as to rotate therewith. This configuration is also used in the prior art references discussed above.

However, it is often advantageous for the plate or membrane to be configured so as to remain stationary while the support element rotates around the plate or membrane, or for the plate or membrane to be rotated at a different speed or even in an opposite direction to the support element. In this way, a significant extra shearing force can be applied to the heat transfer fluid in at least the first space, thus giving much improved beat transfer performance. In particular, it is to be noted that the tangential velocity of the support element will generally be significantly higher than the radial velocity of the heat transfer fluid, thereby ensuring excellent shear stresses and consequently higher heat transfer coefficients for heat transfer between the second surface and the heat transfer fluid. The additional provision of radial or curved fins or vanes on the one side of the plate or membrane with tips that are in close proximity to the rotating second surface of the support element helps to create high local shear and improved heat transfer.

It is further to be noted that when a rotating fluid moves towards a central exit (or “sink”), the tendency to maintain or conserve its angular momentum can give rise to a free vortex, as exemplified in a tornado or a typhoon. In these circumstances, the circumferential velocity and its associated pressure drop may be very high, which will severely limit the flow of heat transfer fluid that can be achieved. However, if radial vanes or an open mesh or the like is provided in the second space, for example on the other side of the plate or membrane or on the surface remote from the second surface, the high circumferential heat transfer fluid velocities can be avoided because the interaction between the heat transfer fluid and the vanes or mesh or the like results in the establishment of a forced rather than a free vortex. This is of advantage both where the plate or membrane is fixed relative to the support element a-ad where it is stationary or rotates relative to the support element.

The provision of vanes or mesh or the like in the first space can also help to reduce the formation of free vortices, especially in embodiments where the plate or membrane rotates, since the vanes or mesh or the like impart a significant tangential velocity to the heat transfer fluid at the periphery and thereby help to promote forced rather than free, vortex formation in the second space.

The plate or membrane may be made of a thermally insulating material, such as a polymeric material, so as to reduce heat transfer between its first and second surfaces, and thus between inwardly and outwardly flowing heat transfer fluid.

For a better understanding of the present invention and to show how it may be carried into effect, reference shall now be made by way of example to the accompanying drawings, in which:

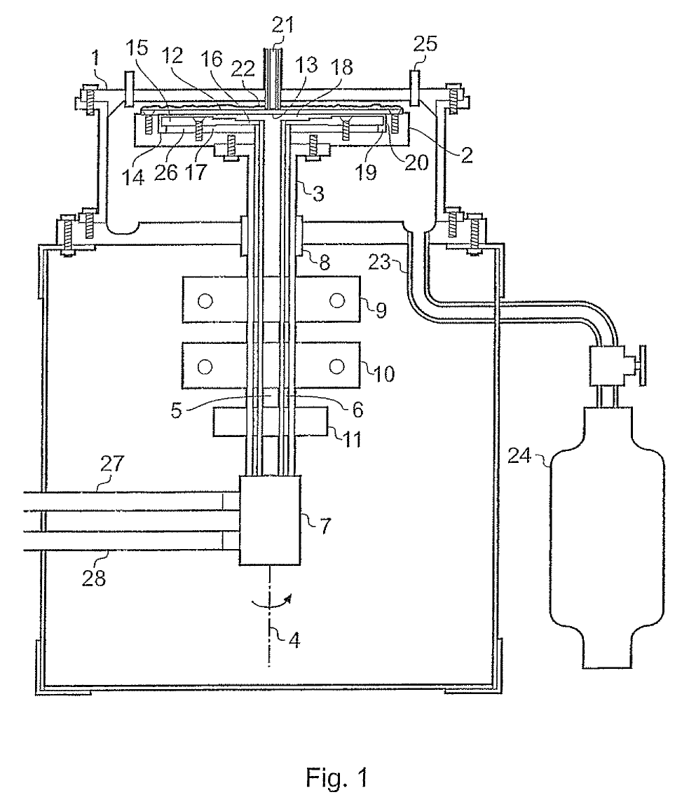

FIG. 1 shows a first embodiment of the present invention;

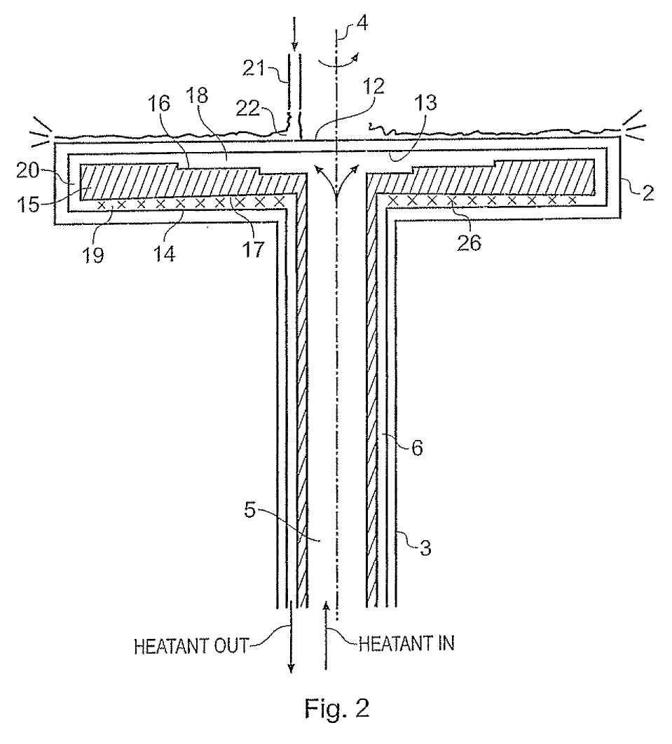

FIG. 2 shows a detail of a second embodiment of the present invention; and

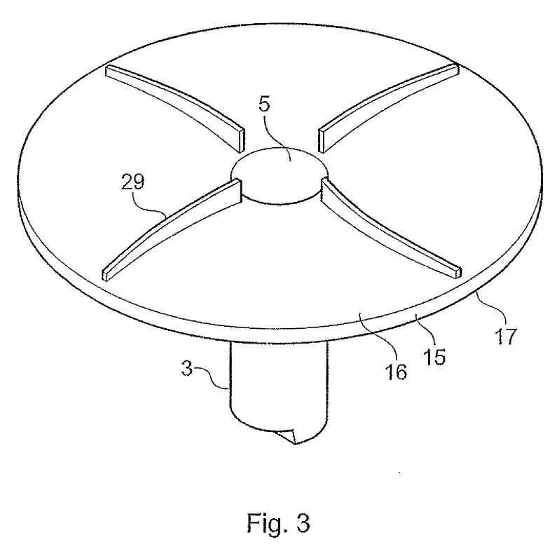

FIG. 3 shows a detail of a third embodiment of the present invention.

FIG. 1 shows a sealed housing 1 in which is mounted a rotatable disc-shaped support element 2 mounted on an axle 3 defining an axis of rotation 4. The axle 3, as well as serving to rotate the support element 2, is hollow and defines a pair of concentric pipes 5, 6 through which heat transfer fluid can be abstracted and removed by way of collector 7. The axle 3 passes out of the housing 1 by way of a rotary seal 8 and is supported by bearings 9, 10. A drive unit 11 serves to rotate the axle 3 at high speed. The support element 2 has a first, external reaction surface 12 and a second, internal surface 13 opposed to the first surface 12. The support element 2 also has a third, internal surface 14 opposed to the second surface 13. A spreader plate 15 is provided inside the support element 2, the spreader plate 15 having first 16 and second 17 surfaces respectively facing the second 13 and third 14 surfaces of the support element 2. A first space 18 is defied between the surfaces 13, 16 and a second space 19 is defied between the surfaces 14, 17, with a peripheral gap 20 allowing communication between the first 18 and second 19 spaces. The first surface 16 of the spreader plate 15 is provided with a stepped profile (in the form of annular steps) such that the first space 18 decreased in width towards the periphery. The second surface 17 of the spreader plate 15 is provided with radial fins or mesh 26, and the spreader plate 15 is bolted to the third surface 14 of the support element 2 so as to rotate therewith.

A feed pipe 21 supplies liquid reactant 22 to a central part of the first surface 12, and an outlet 23 collects material that is thrown from a periphery of the first surface 12 for storage in a vessel 24. A gas inlet/outlet 25 allows the housing 1 to be pressurised or evacuated.

During use, the support element 2 is rotated at high speed by the drive unit 11 and reactant 22 is supplied by way of the feed pipe 21. The reactant 22 then passes radially across the first surface 12 as a thin wavy film before being thrown from the periphery of the first surface 12 and is then removed from the housing 1 by way of outlet 23.

Simultaneously, a heat transfer fluid (not shown) is supplied up the pipe 5, through the first space 18 (which runs full) radially outward towards the peripheral gap 20 and then therethrough to the second space 19 (which also runs full) before flowing radially inwardly and then out through the pipe 6. The heat transfer fluid may be supplied from and recycled to a constant temperature bath (not shown) by way of the collector 7 and input/output pipes 27, 28.

Because the first surface 16 of the spreader plate 15 has a stepped profile resulting in a progressive narrowing of the first space 18 towards its periphery, the radial velocity of the heat transfer does not increase significantly towards the periphery, and heat transfer from the first, reaction surface 12 to the heat transfer fluid is thus improved.

The vanes or mesh 26 on the second surface 17 of the spreader plate 15 helps to prevent free vortex formation in the second space 19.

FIG. 2 shows a detail of an alternative embodiment, with like parts being labelled as for FIG. 1. The housing bearings and drive unit are omitted from FIG. 2 for clarity. As in FIG. 1, the first surface 16 of the spreader plate 15 has a stepped profile. However, the second surface 17 of the spreader plate 15 in tis embodiment has a concave conical profile with the width of the second space 19 increasing towards the axis 4, thereby helping to slow the inward radial velocity of the heat transfer fluid. The most important difference from the embodiment of FIG. 1 is that the spreader plate 15 is not fixed to the support element 2, but is arranged to remain stationary while the support element 2 rotates. This helps to increase shearing in the heat transfer fluid and thereby to increase heat transfer performance. Furthermore, the mesh 26 in the FIG. 2 embodiment is not fixed to the second surface 17 of the spreader plate 15, but instead is fixed to the third surface 14 of the support element 2 so as to rotate therewith and to promote forced vortex formation.

FIG. 3 shows an alternative configuration for the spreader plate 15. In this variation, the first surface 16 is not profiled, but is intended for use with a support element 2 having a profiled second surface 13 so as to vary the width of the first space 18 along its radius. Most significantly, he first surface 16 of the spreader plate 15 is provided with radial fins 29 which taper in height towards the periphery so as to be accommodated in the profiled first space 18. The is 29 are sufficiently tall so as to give only a very fine clearance between the fins 29 and the second surface 13 of the support element 2, thereby promoting shear in the heat transfer fluid and thus improving heat transfer performance.

The preferred features of the invention are applicable to all aspects of the invention and may be used in any possible combination.

Throughout the description and claims of this specification, the words “comprise” and “contain” and variations of the words, for example “comprising” and “comprises”, mean “including but not limited to”, and are not intended to (and do not) exclude other components, integers, moieties, additives or steps.

1. A reactor apparatus including a hollow support element adapted to be rotatable about an axis, the support element having a first, external reaction surface and a second, internal heat transfer surface and means for applying a heat transfer fluid to the second surface, the first and second surfaces being in thermal communication with each other and the support element including an internal space bounded on one side by the second surface, wherein a plate or membrane is provided inside the hollow support element, the plate or membrane extending substantially over the whole internal space so as to define a first space between the second surface and one side of the plate or membrane and a second space between an opposed side of the plate or membrane and an internal surface of the support element remote from the second surface, but leaving a gap at a periphery of the plate or membrane so as to allow a heat transfer fluid to flow between the first and second spaces, characterised in that at least one of the plate or membrane and the second surface is shaped or profiled so that a distance between the one side of the plate or membrane and the second surface varies along a radius taken from the axis.

2. An apparatus as claimed in claim 1, wherein at least one of the other side of the plate or membrane and the internal surface of the support element remote from the second surface is also profiled or shaped so that the distance between the other side of the plate or membrane and the internal surface remote from the second surface varies along a radius taken from the axis.

3. An apparatus as claimed in claim 1, wherein the one side of the plate or membrane has a stepped profile.

4. An apparatus as claimed in claim 1, wherein the one side of the plate or membrane has a conical profile.

5. An apparatus as claimed in claim 1, wherein the one side of the plate or membrane has a parabolic or hyperbolic profile.

6. An apparatus as claimed in claim 1, wherein the second surface of the support element has a stepped profile.

7. An apparatus as claimed in claim 1, wherein the second surface of the support element has a conical profile.

8. An apparatus as claimed in claim 1, wherein the second surface of the support element has a parabolic or hyperbolic profile.

9. An apparatus as claimed in claim 1, wherein the plate or membrane is fixed relative to the support element so as to rotate therewith.

10. An apparatus as claimed in claim 1, wherein the plate or membrane is configured so as to remain stationary when the support element rotates.

11. An apparatus as claimed in claim 1, wherein the plate or membrane is configured so as to rotate at a different speed and/or in a different direction to the support element.

12. An apparatus as claimed in claim 1, wherein radial vanes or fins are provided in the first space.

13. An apparatus as claimed in claim 1, wherein a mesh is provided in the first space.

14. An apparatus as claimed in claim 1, wherein radial vanes or fins are provided in the second space.

15. An apparatus as claimed in claim 1, wherein a mesh is provided in the second space.

16. An apparatus as claimed in claim 1, wherein the plate or membrane is made of a thermally insulating material.

17. (canceled)

18. An apparatus as claimed in claim 2, wherein the one side of the plate or membrane has a stepped profile.

19. An apparatus as claimed in claim 2, wherein the one side of the plate or membrane has a conical profile.

20. An apparatus as claimed in claim 2, wherein the one side of the plate or membrane has a parabolic or hyperbolic profile.

21. An apparatus as claimed in claim 2, wherein the second surface of the support element has a stepped profile.
